(19) United States
(12) Patent Application Publication
(10) Pub. No.: US 2008/0163411 A1
(43) Pub. Date: Jul. 10, 2008

(54) URINAL SYSTEM FOR TRUCKS

(75) Inventors: Michael Brown, Spring Mills, PA (US); Edward Carleton, Elkton, MD (US); Naotomo Gibson, Milton, FL (US); Ian Orzalli, Silverdale, WA (US)

Correspondence Address: INTERNATIONAL TRUCK INTELLECTUAL PROPERTY COMPANY,, 4201 WINFIELD ROAD, P.O. BOX 1488, WARRENVILLE, IL, 60555, US

(73) Assignee: International Truck Intellectual Property Company, LLC, Warrenville, IL (US)

(21) Appl. No.: 11/952,699

(22) Filed: Dec. 7, 2007

Related U.S. Application Data
(60) Provisional application No. 60/883,550, filed on Jan. 5, 2007.

(51) Int. Cl. B60R 15/04

(52) U.S. Cl. 4/114.1

(57) ABSTRACT

A stowable urinal for installation in a vehicle passenger compartment, such as a sleeper compartment of a truck tractor includes a cabinet housing a cleaning fluid reservoir, a pump, a spring-loaded spindle on which hose is wound and a funnel connected to the hose. The funnel is stowed with one face on the outside of the cabinet allowing the funnel to be removed from the cabinet to a position where it is conveniently used by a man to urinate. The hose is attached to a spindle, which is spring loaded and which rotates to wind the hose on the spindle when the funnel is returned to its stowed position on the cabinet. The cleaning fluid reservoir and pump provide for the delivery of cleaning fluid to the stowed funnel for cleaning.

### REFERENCE TO RELATED APPLICATION

The present application is based on U.S. Provisional Application Ser. No. 60/883,550 filed 5 Jan. 2007. Priority based on this provisional application is claimed.

### BACKGROUND OF THE INVENTION

1. Technical Field

The present invention relates to a sanitary installation for motor vehicles, and more particularly to a stowable urinal for a truck cab.

2. Description of the Problem

The phenomenon of “trucker bombs”, that is, plastic jugs filled with urine littering the highways, has been reported as a problem of increasing severity. The “bombs” are regarded as an indicator of the time pressure drivers are under. Many drivers feel unable to seek out public restroom facilities before emptying their bladders, and resort to using empty milk jugs.

At least one stowable urinal system is the Waste Collection System (See FIG. 1) used on the Space Transportation System (the “Space Shuttle”). This system provides a urine collection funnel connected to a flexible, extensible hose and suction system for drawing urine into waste processing facilities.

### SUMMARY OF THE INVENTION

The invention provides a stowable urinal for installation in a vehicle passenger compartment, such as a sleeper compartment of a truck tractor. A stowable urinal system includes sections disposed in the passenger compartment and exterior storage elements. The in cab portion includes a cabinet housing a cleaning fluid reservoir, a pump, a spring-loaded spindle on which hose is wound and a funnel connected to the hose is stowed. The funnel is stowed with one face on the outside of the cabinet allowing the funnel to be removed from the cabinet to a position where it is conveniently used by a man to urinate. A hose connected to the bottom of the funnel plays out from the cabinet and carries urine from the funnel to a drain outlet in the bottom of the cabinet for transfer to an external storage flask.

The hose is attached to a spindle, which is spring loaded and which rotates to wind the hose on the spindle when the funnel is returned to its stowed position on the cabinet. The cleaning fluid reservoir and pump provide for the delivery of cleaning fluid to the stowed funnel for cleaning.

Additional effects, features and advantages will be apparent in the written description that follows.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is schematic illustration of a prior art Waste Collection System used on the orbiter section of the Space Transportation System.

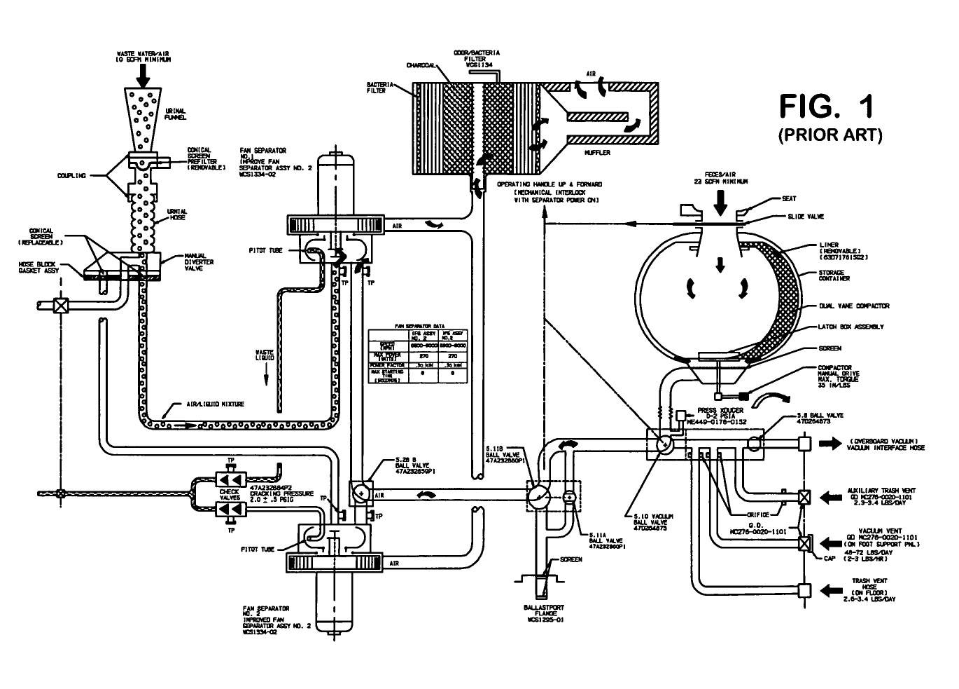

FIG. 2 is a side elevation of a truck tractor equipped with the system of the present invention.

FIG. 3 is a plan view of tractor cab floor.

FIG. 4 is a perspective view of a cabinet housing a stowable urinal.

FIG. 5 is a view of the stowable urinal system opened for use.

FIG. 6 is a cross sectional view of a cabinet housing the stowable urinal.

FIG. 7 is a perspective view of a funnel for the stowable urinal system.

FIG. 8 is a perspective view of a containment flask for use with the invention.

FIG. 9 is a perspective view of a spindle position locking mechanism.

### DETAILED DESCRIPTION OF THE INVENTION

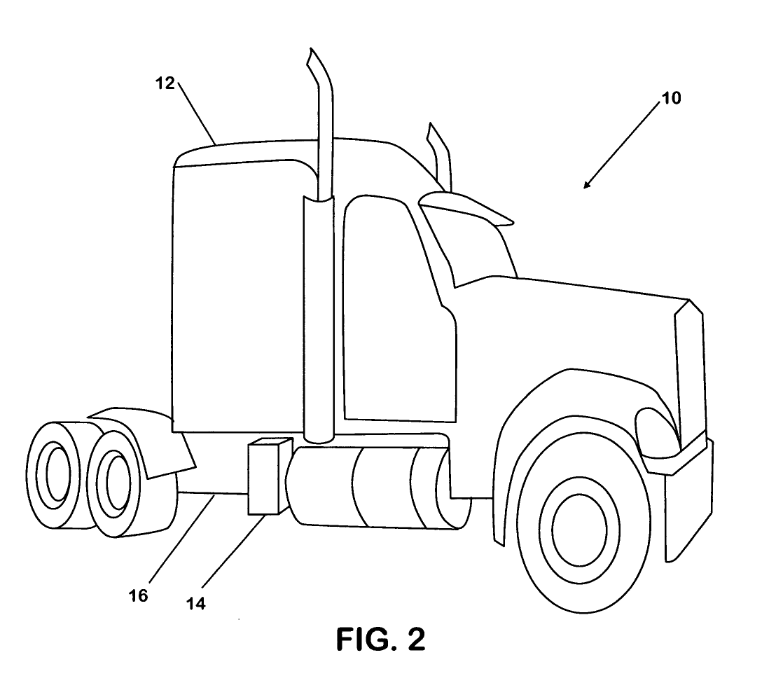

Referring now to the drawings and in particular FIG. 2, a stowable urinal in accordance with the invention is described in connection with its preferred place of use, a truck tractor 10 having a sleeper cab 12. Sleeper cab 12, as described below, is equipped with a stowable urinal. Urine is collected in a removable collection and storage container, which when installed on the truck tractor 12 is located in a housing 14 hanging from below the sleeper cab 12 or installed on frame rails 16.

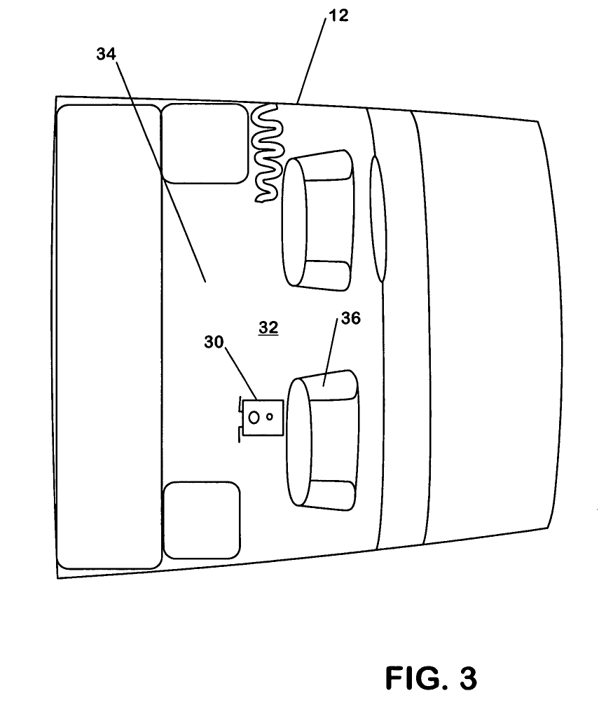

FIG. 3 illustrates a preferred location for a stowable urinal cabinet 30, which is located supported on a cab floor 32 in the sleeper compartment 34 of cab 12, behind the passenger seat 36. The stowable urinal is intended for use by a standing individual, and is positioned to make its use discrete.

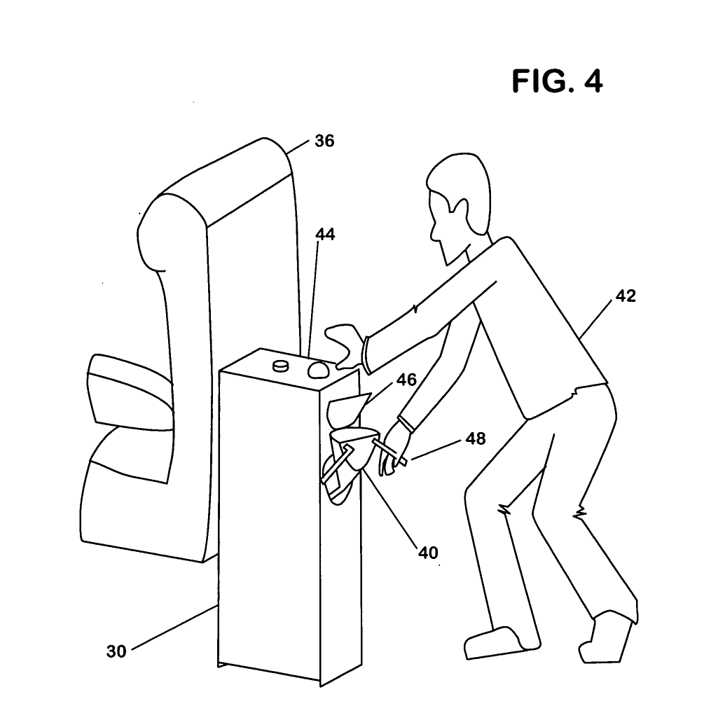

Referring to FIG. 4, a user 42 is illustrated withdrawing a funnel 40 from the stowable urinal cabinet 30 by grasping one of handles 48 and pulling the funnel from the cabinet. A pop up lid 46 opens to expose the interior of the funnel 40. A pump button 44 is shown on top of the cabinet which may be depressed to force cleaning fluid through the funnel 40 after use.

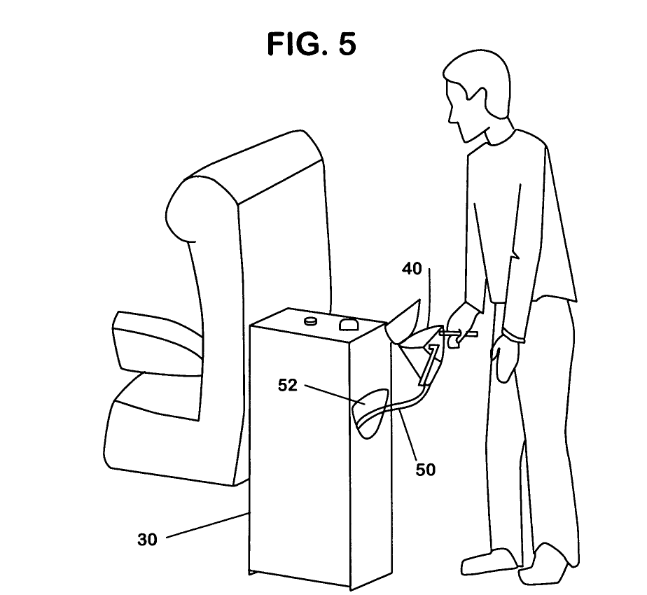

FIG. 5 illustrates the complete removal of the funnel 40 from the cabinet 30 and positioning of the funnel for use by an individual. A hose 50 extends from the funnel 40 back into the cabinet 30 through an opening left in the cabinet by withdrawal of the funnel, to a point of connection within the cabinet to a collection flask.

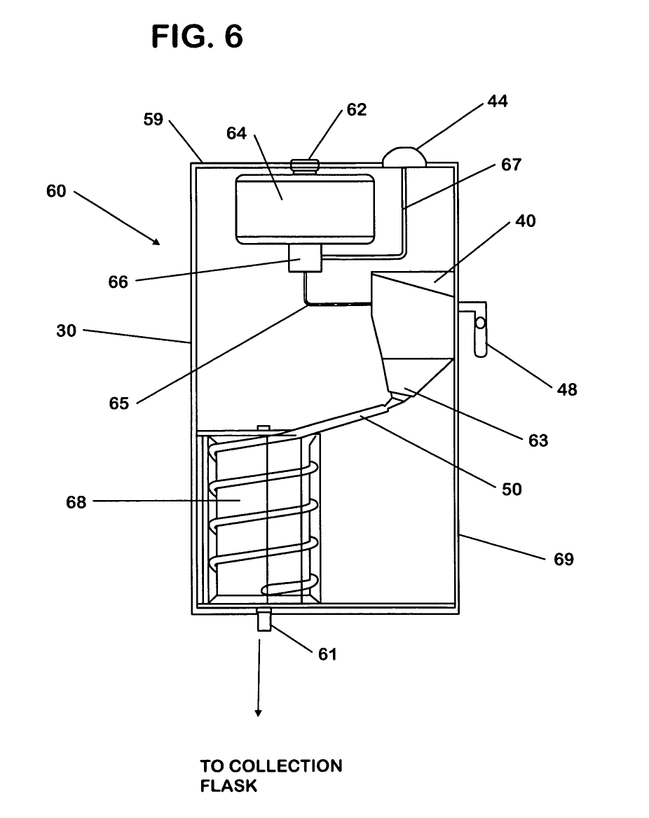

FIG. 6 illustrates those components of a stowable urinal system 60 housed in cabinet 30. In addition to funnel 40 when not in use, the cabinet 30 houses 60 includes a cleaning fluid reservoir 64, a pump 66 and a spring-loaded spindle 68 on which hose 50 is wound when the funnel 40 is stowed. A front face of the funnel 40 is flush with the forward facing outside surface of the cabinet 30. Spring loading of the spindle 68 provides for automatic rewinding of the hose 50 on the spindle. The spring system is not shown, and other retraction systems could be used, such as a small electric motor.

Functionally, the components of the stowable urinal system 60 provide for locating the funnel 40 when not in use, automatically retracting and winding the hose 50 by which urine and cleaning fluid are drained from the funnel to a collection flask, and storing and delivering cleaning fluid to the funnel 40. Additional features of the cabinet 30 are attendant to those functions including an inlet 62 provided through the upper wall 59 into reservoir 64, by which cleaning fluid is added to the reservoir, a pump button 44 which is appropriately linked 67 to a pump 66 mounted to the underside of the reservoir and a tube 65 from the pump to a point within the cabinet where it mates with the funnel 40 when the funnel is positioned on and in the cabinet. By “appropriately linked” it is meant that a connection such as a mechanical linkage is provided to actuate pump 66, or wires are provided allowing a motor driven pump to be turned on. The specific character of the pump 66 is not critical to the invention, though a manually powered system rather than an electrical system may be preferred. A cradle 63 extends from the inner face of forward wall 69 in which funnel 40 can rest after insertion through opening 52. The cradle 63 is adjacent an opening in the wall into which funnel 40 can be inserted when not in use. The cradle 63 and opening 52 provide a receptacle for stowing the funnel 40 with its forward face flush with the outer face of the forward wall 69. The hose 50 which connects to the bottom of funnel 40 plays off spindle 68, which is spring loaded and automatically rewinds the hose as and when the funnel is returned to its cradle 63. Hose 50 connects through spindle 68 to a pipe which leads to connector/outlet 61 to an externally positioned collection flask.

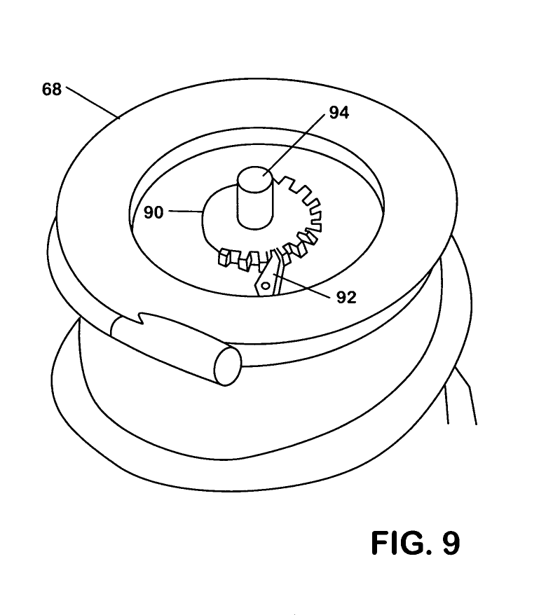

Spindle 61 preferably includes a retraction locking mechanism which prevents snap back of funnel 40 into cabinet 30 unless replacement of the funnel is restrained. A possible mechanism for locking the spindle 61 is illustrated in FIG. 9.

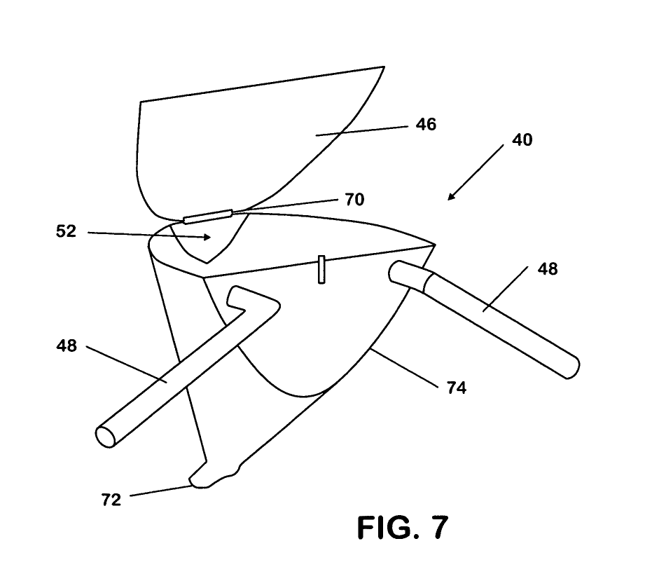

FIG. 7 illustrates features of funnel 40. Funnel 40 includes a spout 72 for connection to hose 50. Pop up lid 46 is connected to a funnel cup 74 along a sprung hinge 70. An orifice 52 is located along the back wall of the funnel cup 74. When funnel 40 is returned to cradle 63 the orifice 52 is aligned on tube 65 allowing for the injection of cleaning fluid through the tube into the cup 74 of the funnel.

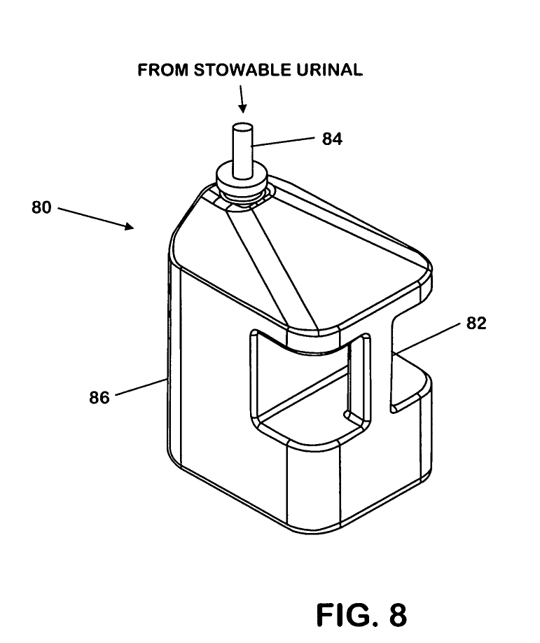

FIG. 8 illustrates a collection flask 80 which is preferably kept (when in use) in housing 14 and which provides an extended neck 84 by which it is connected through an opening in the floor of a truck cab to outlet 61 from spindle 68. Collection flask 80 includes a molded, heavy duty plastic body 86 of approximately 4 liters capacity. An integral handle 82 by which the collection flask 80 may be carried and making it convenient to remove the flask in order to empty its contents into a toilet is molded into collection flask 86. Alternatively, a hose (not shown) may be used to connect the outlet 61 from the spindle 68 to the flask 80.

FIG. 9 illustrates a snap back preventing lock on spindle 68, comprising a toothed sprocket 90 and spring loaded locking pawl 92. Sprocket 90 is mounted on axle 94 and does not rotate with the spindle 68 on the axle. A spring loaded swinging pawl 92 is attached to the top of the spindle 68 and interacts with the sprocket 94 to prevent unintended snap back return of the spindle 68 if the funnel 40 is dropped.

While the invention is shown in only one of its forms, it is not thus limited but is susceptible to various changes and modifications without departing from the spirit and scope of the invention.

What is claimed is:

1. A stowable urinal system for a vehicle passenger compartment, comprising:
a funnel;
a cabinet for installation in the vehicle passenger compartment, the cabinet including a receptacle for receiving the funnel along a face of the cabinet;
a spindle mounted inside the cabinet; and
a hose attached between the funnel and the spring-loaded spindle, the spindle providing for retracting the funnel into the receptacle and storage of the hose wound upon the spindle.

2. A stowable urinal system in accord with claim 1, further comprising:
a drain from the hose through the spindle to a collection flask.

3. A stowable urinal system in accord with claim 2, further comprising:
the spindle including an automatic rewind mechanism and spindle position locking system.

4. A stowable urinal system in accord with claim 3, further comprising:
a cleaning fluid reservoir located in the cabinet;
a fluid delivery line from the cleaning fluid reservoir for connection to the funnel when stowed; and
a pump in the fluid delivery line for urging cleaning fluid from the cleaning fluid reservoir to the funnel.

5. A stowable urinal system in accord with claim 4, further comprising:
a housing externally positionable on a truck tractor for locating a removable storage flask.

6. A sleeper cab having a floor for a tractor comprising:
a floor mounted cabinet;
an opening in one face of the cabinet;
a funnel stowable in the opening;
a hose attached at a first end to the funnel and extending from the funnel into the floor mounted cabinet; and
a spindle mounted for rotation in the floor mounted cabinet, the hose being connected at a second end to the spindle, the spindle providing for winding the hose for stowage and playing out of the hose to allow withdrawal of the funnel from the opening for use.

7. A sleeper cab in accord with claim 6, further comprising:
a drain from the hose through the spindle to a collection flask installed on the outside of the sleeper cab.

8. A sleeper cab in accord with claim 7, further comprising:
the spindle including an automatic rewind mechanism and spindle position locking system.

9. A sleeper cab in accord with claim 8, further comprising:
a cleaning fluid reservoir located in the floor mounted cabinet;
a fluid delivery line from the cleaning fluid reservoir for connection to the funnel when disposed in the opening; and
a pump in the fluid delivery line for urging cleaning fluid from the cleaning fluid reservoir to the funnel.

10. A sleeper cab in accord with claim 9, further comprising:
a housing positioned depending from the sleeper cab for enclosing a removable storage flask; and
a hose between the spindle and the housing which is connectable to a removable storage flask which provides for collection of fluid drained from the funnel.
